(19) United States
(12) Patent Application Publication
(10) Pub. No.: US 2025/0390934 A1
(43) Pub. Date: Dec. 25, 2025

(54) PREDICTING INCREMENTAL LIFT ON ITEM CONVERSIONS CAUSED BY IN-STORE SAMPLE BOOTH USING A TRAINED MODEL

(71) Applicant: Maplebear Inc., San Francisco, CA (US)

(72) Inventors: Charles Wesley, San Diego, CA (US); Brent Scheibelhut, Toronto (CA)

(21) Appl. No.: 18/750,216

(22) Filed: Jun. 21, 2024

(51) Int. Cl. G06Q 30/0601; G06Q 30/02; G06Q 30/0201

(52) U.S. Cl. CPC G06Q 30/0639; G06Q 30/0201; G06Q 30/0281; G06Q 30/0623

(57) ABSTRACT

An online system uses a trained model to predict incremental sales caused by a sample counter for in-store free sampling of an item. Upon receiving signals related to in-store purchases of the item, the online system applies the trained model to output, based on the received signals, a ranked list of locations of a source and a ranked list of timeslots for placing the sample counter. The online system selects, from the ranked list of locations and the ranked list of timeslots, a location of the source and a timeslot for placing the sample counter, and generates a decision signal based on the selected location and the selected timeslot. The online system communicates, via the network to a device associated with the source, the decision signal prompting the source to place the sample counter for free sampling of the item at the selected location and during the selected timeslot.

### BACKGROUND

Sources associated with an online system often have counters at their locations (e.g., stores) to provide free samples of promotional items to their customers as well as to users of the online system that conduct in-store shopping. However, the decisions about which locations and which times to set up a sample counter for a brand or a specific item to provide free samples in a chain of stores are typically made based on human intuition, which may not be optimal. Therefore, it is desirable to automatically and at a large scale identify optimal store locations and times for setting up a sample counter to provide free samples for promotion of a specific item.

### SUMMARY

Embodiments of the present disclosure are directed to using a trained machine-learning model of an online system to predict incremental lift on item conversions caused by an in-store sample booth. In this manner, the use and distribution of sample booths (i.e., sample counters) to promote items at source locations can be optimized.

In accordance with one or more aspects of the disclosure, the online system receives, via a network from at least one of a first set of devices associated with a first set of users of the online system or a second set of devices associated with a set of physical receptacles utilized by a second set of users of the online system for shopping at a set of source locations of a source associated with the online system, a plurality of signals related to conversion of an item by at least one of the first set of users or the second set of users. The online system accesses a machine-learning model of the online system, wherein the machine-learning model is trained to identify a ranked list of source locations from the set of source locations for placing a sample counter for sampling the item, each source location from the ranked list associated with a corresponding timeslot of a ranked list of timeslots. The online system applies the machine-learning model to output, based at least in part on the plurality of signals, a score for placing the sample counter for sampling the item at each source location from the set of source locations and during each timeslot of a set of timeslots, wherein the score is indicative of a predicted increase in conversion of the item caused by the sample counter placed at each source location and during each timeslot. The online system identifies, based on the score associated with at each source location and each timeslot, the ranked list of source locations and the ranked list of timeslots for placing the sample counter for sampling the item. The online system selects, from the ranked list of source locations and the ranked list of timeslots, a source location and a timeslot for placing the sample counter for sampling the item. The online system generates, based on the selected source location and the timeslot, a decision signal for the source. The online system communicates, via the network to a device associated with the source, the decision signal prompting the source to place the sample counter for sampling the item at the selected source location and during the selected timeslot.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example smart shopping cart associated with an online system, in accordance with one or more embodiments.

FIG. 4 illustrates an example architectural flow diagram of using a trained machine-learning model of an online system to optimize free sampling of items at source locations, in accordance with one or more embodiments.

FIG. 5 is a flowchart for a method of using a trained machine-learning model of an online system to optimize free sampling of items at source locations, in accordance with one or more embodiments.

### DETAILED DESCRIPTION

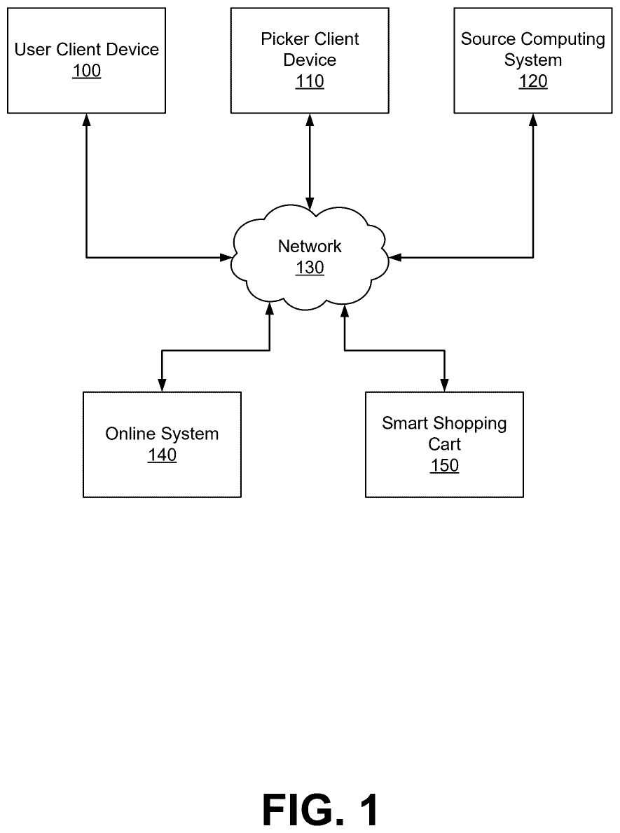

FIG. 1 illustrates an example system environment for an online system 140, in accordance with one or more embodiments. The system environment illustrated in FIG. 1 includes a user client device 100, a picker client device 110, a source computing system 120, a network 130, an online system 140, and a smart shopping cart 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with the smart shopping cart 150 being used by a user to collect items in a source location. For example, the smart shopping cart 150 may display content received from the online system 140 and may receive data describing items that are collected by the user and stored in a storage area of the shopping cart. In some embodiments, the smart shopping cart 150 is a picker client device 110 being operated by a picker collecting items within a source location. Similarly, the smart shopping cart 150 may be operated by a user within the source location collecting items for themselves. Example embodiments of smart shopping carts 150 are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

A source associated with the online system 140 may invite consumer packaged goods (CPG) companies into a source location to set up sample counters to increase sales of certain items. Similarly, the source may set up its own sample counters to provide free samples of items to increase their sales. In such cases, the online system 140 deploys a machine-learning model that is trained to predict incremental sales caused by in-store sample counters that provide free samples of items (e.g., grocery items) for in-store shoppers (e.g., source customers and/or in-store users of the online system 140). The machine-learning model may take as inputs various features related to an item to be promoted, the source location (e.g., location of the store), historical user data, etc. The historical user data may be derived from online orders (e.g., orders placed by user client devices 100), in-store orders (e.g., orders that utilize an in-store application of the online system 140 running on user client devices 100), user data gathered by one or more sensors of the smart shopping cart 150, etc. The machine-learning model of the online system 140 may be trained using examples that are labeled with incremental sales determined from historical trends.

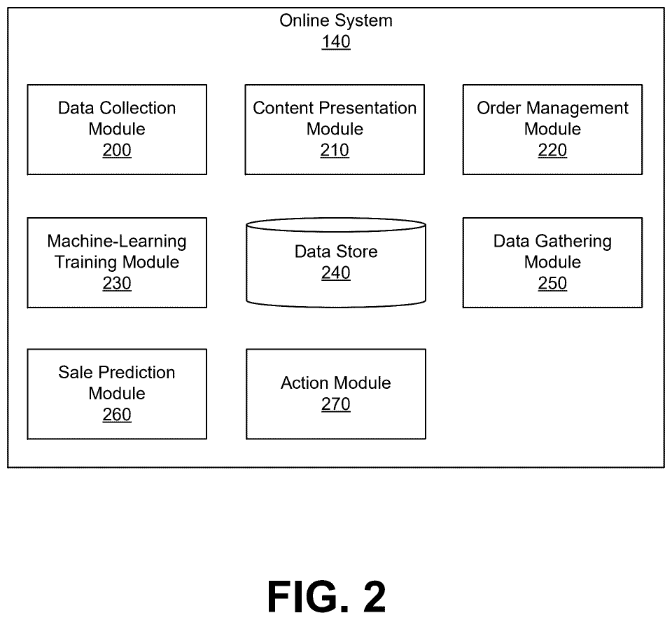

The incremental sales predicted by the machine-learning model of the online system 140 may enable sources and brand owners to optimize limited budgets allocated for in-store sample counters. The online system 140 may utilize outputs of the machine-learning model to provide insights to sources and/or CPG companies in relation to what stores should they run their in-store sample counters in, and when should they run the in-store sample counters in order maximize or at least increase impact of the in-store sample counters on users' purchasing behavior. The online system 140 is described in further detail below with regards to FIG. 2.

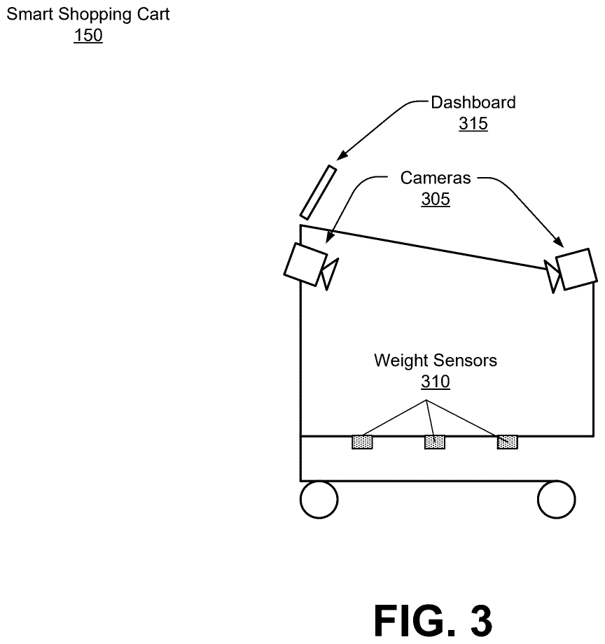

The smart shopping cart 150 is an in-store shopping cart that enables a user of the online system 140 to physically add (i.e., place) items from a source location (e.g., store) into the smart shopping cart 150 and check the items out from the source location without an involvement of an employee of the source at the point of sale. The smart shopping cart 150 may be connected to the online system 140 via the network 130. During the user's shopping session, the smart shopping cart 150 may utilize various sensors (e.g., one or more weight sensors, one or more cameras, etc.) to gather data about the user's activity, including, but not limited to, a location of the smart shopping cart 150 in at source location, weight changes of the smart shopping cart 150 as items are added to or removed from the smart shopping cart 150, video of the user's activity in and around the smart shopping cart 150, images of items added to the smart shopping cart 150, video and/or images of shelfs with items at the source location, etc. In one or more embodiments, the smart shopping cart 150 is considered being a part of the online system 140. It should be noted that the concepts described herein in relation to the smart shopping cart 150 can be extended and/or applied to other form factors, such as a handheld shopping basket, a handheld receptacle, or some other handheld object that can be used to receive and store shopping items. The smart shopping cart 150 is described in further detail below with regards to FIG. 3.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a data gathering module 250, a sale prediction module 260, and an action module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The data gathering module 250 may gather data with information about users' actions at source locations, such as stores. Hence, the gathering module 250 may gather data with information about users' in-store purchasing behaviors. In particular, the data gathering module 250 may gather in-store order data with information about in-store orders broken down by taxonomy nodes, time of day, and location. The in-store data may thus include information about how much of a certain type of item (e.g., cheese) is being sold at a particular store at a certain time of day (and, optionally, at particular days of the week). The data gathering module 250 may receive in-store order data from one or more source computing systems 120 via the network 130.

Additionally or alternatively, the data gathering module 250 may gather purchase data with information about which purchased items were planned in advance for purchase as they were on an in-store mode ordering list of an application of the online system 140 running on one or more user client devices 100 and which purchased items were unplanned as they were not on the in-store mode ordering list. The purchase data may thus include valuable information about which purchased items were the result of on-spot decisions by users as well as information about time and source location associated with the unplanned purchases. The data gathering module 250 may receive the purchase data from the one or more user client devices 100 and/or one or more source computing systems 120 via the network 130.

Additionally or alternatively, the data gathering module 250 may gather in-store data captured by sensors of smart shopping carts 150 used by users of the online system 140 for in-store shopping. The in-store data may include information about how many of the purchases were unplanned as well as information about time and source location associated with the unplanned purchases. For example, the in-store data gathered via the smart shopping carts 150 can include information on how many of purchases of a certain brand of item (e.g., certain brand of cheese) were intended purchases as users enter the store, purchase the item, and get out of the store, and how many of these purchases were unintended purchases as users enter the store and make decisions in-store about what brand of item (e.g., brand of cheese) to buy. The in-store data may further provide information on how frequently users of the smart shopping carts 150 are “lingering” in certain sections of the store, which is a proxy for browsing behavior of certain users. Note that the more users are browsing inside the store and then purchasing a certain brand of item, the more impact a sample counter would have on future sales of this brand of item. The data gathering module 250 may receive the in-store data from the smart shopping carts 150 via the network 130. Additionally, the data gathering module 250 may aggregate, as part of the in-store data per source location, information about “adventurousness” scores and/or “browser” scores for users of the online system 140, e.g., by retrieving these scores from the data store 240.

FIG. 3 illustrates an example smart shopping cart 150 associated with the online system 140, in accordance with one or more embodiments. The smart shopping cart 150 may have one or more cameras 305 that collect video data and/or image data in relation to shelfs (i.e., store aisles) with various stored items as a user that utilizes the smart shopping cart 150 for in-store shopping is passing by. The one or more cameras 305 may further collect video data and/or image data in relation to items placed in the smart shopping cart 150, such as a weight of each item as indicated in an item label, a brand of each item, a name of each item, a price of each item, etc. Additionally, the one or more cameras 305 may collect video data and/or image data in relation to actions in and around the smart shopping cart 150, such as a location of the smart shopping cart 150 in a source location (e.g., store) when a certain action occurs (e.g., when an item is added to the cart), user's gestures when placing items in the smart shopping cart 150, video and/or images of user's interactions with the smart shopping cart 150, track the location of the user in the source location, measure a velocity of the smart shopping cart 150 in the store, etc. Alternatively or additionally, the smart shopping cart 150 may be equipped with one or more weight sensors 310 that measure weights of items placed in the smart shopping cart 150.

The smart shopping cart 150 may further include a dashboard 315 that operates as a user interface that displays a list of items added to a receptacle of the smart shopping cart 150 and can be used for the checkout. The dashboard 315 may be further used for providing notifications to the user that utilizes the smart shopping cart 150 for in-store shopping. The smart shopping cart 150 may include additional sensors not shown in FIG. 3. The dashboard 315 or some other component of the smart shopping cart 150 may further include a computing system that is in communication with the user client device 100, the source computing system 120 and/or the online system 140 via the network 130. Data gathered by various sensors of the smart shopping cart 150 may be uploaded via the network 130 at the online system 140 (e.g., via the data gathering module 250) to be used as input features for a trained machine-learning model, such as image data, scanning data, video data, etc. related to items added by the user to the smart shopping cart 150 as well as to user's behavior at the retail store.

The sale prediction module 260 may access a sale prediction model (e.g., machine-learning model) that is trained to predict incremental sales caused by a sample counter for a particular item when the sample counter is placed at a specific location of a source associated with the online system 140. The sale prediction module 260 may deploy the sale prediction model to run a machine-learning algorithm to output, based on a set of inputs, a ranked list of source locations and times for placing a sample counter for providing free samples of a given item. In addition to the aforementioned data gathered via the data gathering module 250 with information about the historical users' interactions, the set of inputs for the sale prediction model may further include information about a candidate item to be promoted with a sample counter (e.g., as retrieved from an item collection database stored at the data store 240). Hence, given certain information about an item to be “sampled” (e.g., taxonomy node, product name, brand, etc.), the sale prediction model may be trained to output a ranked list of recommended source locations for placing the sample counter for the item, along with a recommended timeslot for each source location. Optionally, the sale prediction model may also output a ranked list of recommended “in-store locations” with information on where inside a source location (e.g., store) to place the sample counter for free sampling of the item. The sale prediction module 260 may then select, from the ranked list of recommended source locations, one or more source locations and one or more corresponding timeslots for placing a sample counter for a given item, i.e., the highest ranked source location(s). A set of parameters for the sale prediction model may be stored at one or more non-transitory computer-readable media of the sale prediction module 260. Alternatively, the set of parameters for the sale prediction model may be stored at one or more non-transitory computer-readable media of the data store 240.

In one or more embodiments, the sale prediction model runs a machine-learning algorithm against the item catalog database (e.g., as available at the data store 240) to facilitate sources and/or CPG companies discover what items might be particularly responsive to being sampled. In such cases, the sale prediction model may be trained to output a ranked list of items for sampling as well as a source location and a timeslot for placing a sample counter for free sampling of each item in the ranked list. In addition to using the performance data of past sample counters for other items as inputs to the sale prediction model, the sale prediction model may also consider candidate items with low penetration but high retention among users who purchased them in the past, which represents a high opportunity to capture more users (e.g., high addressable market).

Once preferred source locations and timeslots for placing sample counters for free sampling of a given set of items are identified by the sale prediction model, the sale prediction model may pass data with information about the preferred source locations and the timeslots for placing the sample counters to the content presentation module 210. The content presentation module 210 may then utilize this data to generate a user interface of the user client device 100 and/or a user interface of the dashboard 315 of the smart shopping cart 150 with a map of sample counters. The map of sample counters may be thus added to the in-store application of the online system 140 running on the user client device 100 or the user interface of the smart shopping cart 150 so users can see what sample items are available, information about the sample items, and where to try these items. The user interface that shows the map of sample counters also facilitates advertisement of these items. Additionally, to facilitate a user's purchase decision, the user interface generated by the content presentation module 210 may include a one-tap “add to ordering list” for any sample counter the user is at. In this manner, the generated user interface may optimize the in-store experience for users.

The machine-learning training module 230 may perform initial training of the sale prediction model using training data. The machine-learning training module 230 may generate the training data by retrieving (e.g., from the data store 240) historical sales data for a collection of items, with and without sample counters, making assumptions about the incremental sales influenced by the sample counters. Additionally or alternatively, the machine-learning training module 230 may generate the training data that include cold start data, i.e., data obtained from sources with information about effects of sample counters on incremental sales of sampled items. The machine-learning training module 230 may train the sale prediction model using the training data to generate initial values for the set of parameters of the sale prediction model.

Based on the output of the sale prediction model (i.e., ranked list of recommended source locations and timeslots for placing a sample counter for a given item), the action module 270 may generate a decision signal with information about a source location and a timeslot for placing the sample counter. The action module 270 may communicate the decision signal to the source computing system 120, and the source associated with the source computing system 120 may then utilize the decision signal to optimize their use of sample counters to maximize or at least increase impact on future sales.

Over time, the sale prediction model may start optimizing samples in relation to each other. For example, if a source location has too many savory samples at one time, or too many sweet samples, or too many overall samples, source customers and/or users of the online system 140 may become fatigued. At this point, information about a list of all items a source wants to provide samples on may be input to the sale prediction model, and then the sale prediction model may output recommended timeframes and source locations for the list of items while minimizing or at least reducing this kind of user fatigue, in addition to other factors.

Similarly, the ranked list of recommended source locations and timeslots for sample counters for free sampling of various items output by the sale prediction model may be provided to CPG companies to help them maximize or at least reduce the use of samples to increase user awareness and/or demand for their items. Additionally, if “brand ambassadors” for a CPG company are identified as well as “whale” users who are more likely to try new brands, purchase a lot of new items, proselytize the new items to their friends, then the online system 140 presented herein may provide insights to the CPG company about setting up a store specifically to target those very high-value users.

The machine-learning training module 230 may collect feedback data with information about historical sample counter data, such as where at a source location, at which source locations, and during what times the sample counters were placed along with data with information about sales driven by the sample counters. The online system 140 may send (e.g., via the machine-learning training module 230 and/or the action module 270) requests to sources (i.e., source computing systems 120) to provide the sample counter data with information about what source locations they place sample counters in, what places inside source locations they use, and what times those sample counters are active. The data received at the machine-learning training module 230 may include information about how many incremental sales are actually driven by those sample counters, and the received data can then be fed back into the sale prediction model as the feedback data for model re-training. The machine-learning training module 230 may then re-train the sale prediction model by updating the set of parameters of the sale prediction model using the feedback data.

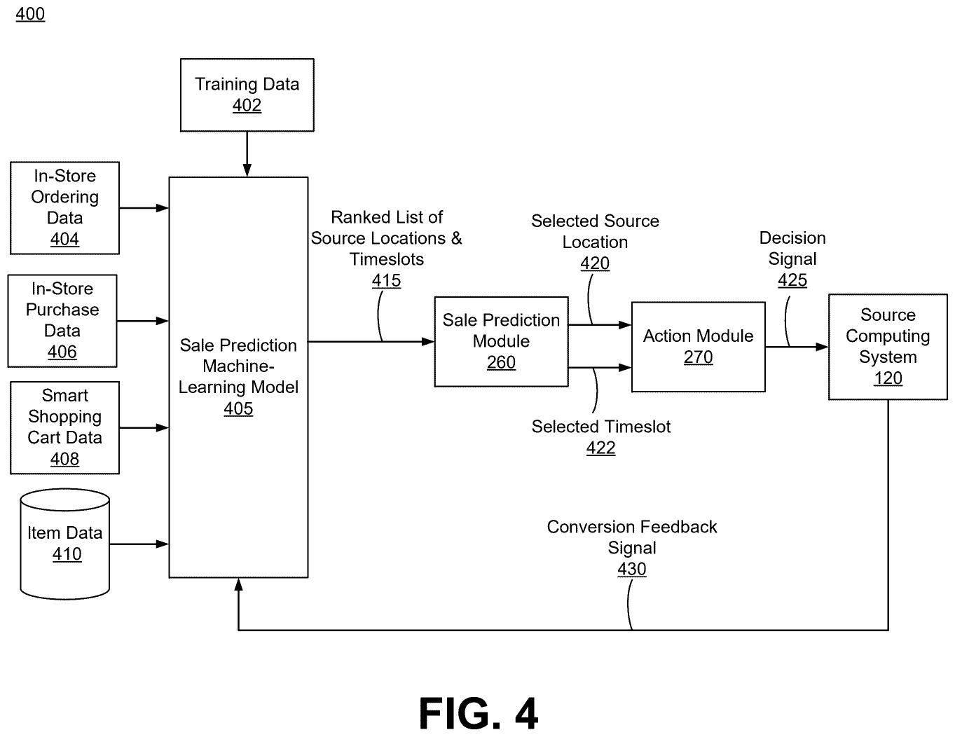

FIG. 4 illustrates an example architectural flow diagram 400 of using a sale prediction machine-learning model 405 of the online system 140 to optimize free sampling of items at source locations, in accordance with one or more embodiments. First, the online system 140 may perform (e.g., via the machine-learning training module 230) initial training of the sale prediction machine-learning model 405 using training data 402 to generate initial values for the set of parameters of the sale prediction machine-learning model 405. The training data 402 may be generated (e.g., via the machine-learning training module 230) based on information about historical sales of a collection of items, with and without sample counters, e.g., retrieved from the data store 240 or received from source computing systems 120 associated with one or more sources. After the training process is completed, the online system 140 may provide various inputs to the sale prediction machine-learning model 405 (e.g., via the sales prediction module 260), such as item data 410 and at least one of in-store ordering data 404, in-store purchase data 406 or smart shopping cart data 408. Some additional input features not shown in FIG. 4 suitable for predicting incremental sales caused by free sampling of an item may be further provided to the sale prediction machine-learning model 405.

In providing the in-store ordering data 404 to the sale prediction machine-learning model 405, the online system 140 may provide (e.g., via the sale prediction module 260) information about in-store orders broken down by taxonomy, time of day, and source location, such as information about how much of a certain item is being sold at a particular source location at a certain time of day. The in-store ordering data 404 may be received at the online system 140 (e.g., via the data gathering module 250) from the source computing system 120 via the network 130.

In providing the in-store purchase data 406 to the sale prediction machine-learning model 405, the online system 140 may provide (e.g., via the sale prediction module 260) data with information about which purchased items were planned in advance for purchase as they were on an in-store mode ordering list of an application of the online system 140 running on one or more user client devices 100 and which purchased items were unplanned as they were not on the in-store mode ordering list. The in-store purchase data 406 may thus represent browsability data for unplanned purchases. The in-store purchase data 406 may be received at the online system 140 (e.g., via the data gathering module 260) from user client devices 100 via the network 130.

In providing the smart shopping cart data 408 to the sale prediction machine-learning model 405, the online system 140 may provide (e.g., via the sale prediction module 260) information about what purchased items were unplanned including information about time and source location associated with the unplanned purchases, information about how frequently users of the smart shopping carts 150 are “lingering” in certain sections of a source location, some other user browsing data gathered via sensors of the smart shopping cart 150, or some combination thereof. The smart shopping cart data 408 may be received at the online system 140 (e.g., via the data gathering module 250) from smart shopping carts 150 via the network 130.

In providing the item data 410 to the sale prediction machine-learning model 405, the online system 140 may provide (e.g., via the sale prediction module 260) data with information about an item that is planned for free sampling at a location of a source associated with the online system 140, such as taxonomy information about the item (e.g., type of item, brand of item, etc.). The online system 140 may retrieve (e.g., via the data gathering module 250 or the sale prediction module 260) the item data 410 from an item catalog database stored at, e.g., the data store 240.

The sale prediction machine-learning model 405 may apply a machine-learning algorithm to the item data 410 and at least one of in-store ordering data 404, the in-store purchase data 406 or the smart shopping cart data 408 to output a ranked list of source locations and timeslots 415 for placing a sample counter for free sampling of the item. The ranked list of source locations and timeslots 415 output by the sale prediction machine-learning model 405 may be passed to sale prediction module 260. The sale prediction module 260 may then select, from the ranked list of source locations and timeslots 415, a preferred source location 420 and a preferred timeslot 422 for placing the sample counter for free sampling of the item. The preferred source location 420 and the preferred timeslot 422 may correspond to the highest ranked source location and timeslot from the ranked list of source locations and timeslots 415.

The action module 270 may generate, based on the selected preferred source location 420 and the selected preferred timeslot 422, a decision signal 425 with information for the source about the selected preferred source location 420 and the selected preferred timeslot 422 for placing the sample counter for free sampling of the item. The action module 270 may communicate the decision signal 425 to the source computing system 120 via the network 130. The decision signal 425 may prompt the source to place the sample counter at the selected preferred source location 420 during the selected preferred timeslot 422.

The source computing system 120 may record a conversion feedback signal 430 with information about incremental conversion of the item caused by the sample counter that was placed for free sampling of the item at the selected preferred source location 420 during the selected preferred timeslot 422. The incremental conversion may correspond to a difference between sales of the item before free sampling of the item and after free sampling of the item at the sample counter placed at the selected preferred source location 420 during the selected preferred timeslot 422. The online system 140 may receive (e.g., via the machine-learning training module 230) the conversion feedback signal 430 from the source computing system 120 via the network 130. The machine-learning training module 230 may utilize the conversion feedback signal 430 to re-train the sale prediction machine-learning model 405. By utilizing the conversion feedback signal 430, the machine-learning training module 230 may update the set of parameters of the sale prediction machine-learning model 405 and continuously improve the machine-learning algorithm of the sale prediction machine-learning model 405.

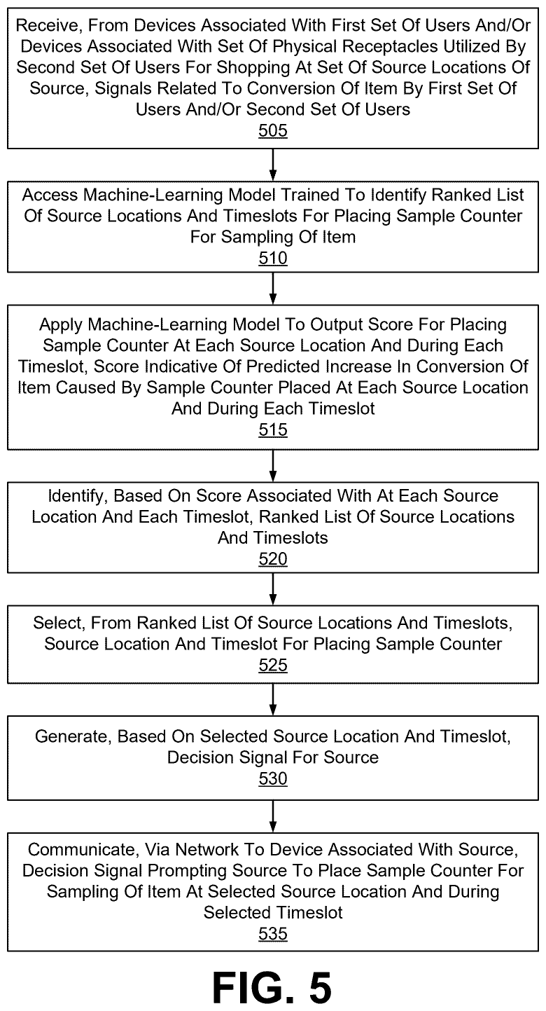

FIG. 5 is a flowchart for a method of using a trained machine-learning model of an online system to optimize free sampling of items at source locations, in accordance with one or more embodiments. Alternative embodiments may include more, fewer, or different steps from those illustrated in FIG. 5, and the steps may be performed in a different order from that illustrated in FIG. 5. These steps may be performed by an online system (e.g., the online system 140). Additionally, each of these steps may be performed automatically by the online system without human intervention.

The online system 140 receives 505 (e.g., via the data gathering module 250), via a network (e.g., the network 130) from at least one of a first set of devices associated with a first set of users of the online system 140 (e.g., user client devices 100) or a second set of devices associated with a set of physical receptacles utilized by a second set of users of the online system 140 for shopping at a set of source locations of a source associated with the online system 140 (e.g., smart shopping carts 150), a plurality of signals related to conversion of an item by at least one of the first set of users or the second set of users.

The online system 140 may receive, via a device associated with the source (e.g., the source computing system 120) and via the network, the plurality of signals including in-store order data with information about conversion of the item at the set of source locations. The online system 140 may receive, from the first set of devices and via the network, the plurality of signals including purchase data with first information about conversion of the item at the set of source locations, second information about the item being in a first subset of in-store mode ordering lists at a first subset of the first set of devices, and third information about the item not being in a second subset of the in-store mode ordering lists at a second subset of the second set of devices.

The online system 140 may gather, via sensors mounted to the set of physical receptacles, in-store data with information about placing of the item in the set of physical receptacles at the set of source locations and information about sections of the set of source locations where the set of physical receptacles were located. The online system 140 may receive, from the second set of devices and via the network, the gathered in-store data as at least a portion of the plurality of signals.

The online system 140 accesses 510 a machine-learning model of the online system 140 (e.g., via the sale prediction module 260), wherein the machine-learning model is trained to identify a ranked list of source locations from the set of source locations for placing a sample counter for sampling the item, each source location from the ranked list associated with a corresponding timeslot of a ranked list of timeslots. The online system 140 applies 515 the machine-learning model (e.g., via the sale prediction module 260) to output, based at least in part on the plurality of signals, a score for placing the sample counter for sampling the item at each source location from the set of source locations and during each timeslot of a set of timeslots, wherein the score is indicative of a predicted increase in conversion of the item caused by the sample counter placed at each source location and during each timeslot. The online system 140 identifies 520 (e.g., via the machine-learning model or the sale prediction module 260), based on the score associated with at each source location and each timeslot, the ranked list of source locations and the ranked list of timeslots for placing the sample counter for sampling the item. The online system 140 may apply the machine-learning model (e.g., via the sale prediction module 260) to output, based at least in part on the plurality of signals, a ranked list of in-store locations for placing the sample counter for sampling the item, each in-store location of the ranked list of in-store locations associated with a source location of the ranked list of source locations. The online system 140 selects 525 (e.g., via the sale prediction module 260), from the ranked list of source locations and the ranked list of timeslots, a source location and a timeslot for placing the sample counter for sampling the item.

The online system 140 may retrieve (e.g., via the prediction module 260), from a database of the online system 140 (e.g., the data store 240), data with information about a set of candidate items. The online system 140 may obtain (e.g., via the data gathering module 250) a second plurality of signals related to conversion of the set of candidate items at the set of source locations. The online system 140 may apply the machine-learning model (e.g., via the sale prediction module 260) to output, further based on the retrieved data and the second plurality of signals, a ranked list of items from the set of candidate items, each item from the ranked list associated with a source location of the set of source locations and a timeslot for placing a corresponding sample counter for sampling each item.

The online system 140 generates 530 (e.g., via the action module 270), based on the selected source location and the timeslot, a decision signal for the source. The online system 140 communicates 535, via the network to a device associated with the source (e.g., the source computing system 120), the decision signal prompting the source to place the sample counter for sampling the item at the selected source location and during the selected timeslot.

The online system 140 may select (e.g., via the sale prediction module 260), from the ranked list of items, one or more items for placing one or more sample counters for sampling the one or more items. The online system 140 may generate (e.g., via the action module 270), based on the selected one or more items, a second decision signal for the source. The online system 140 may communicate (e.g., via the action module 270), via the network to the device associated with the source, the second decision signal prompting the source to place the one or more sample counters for sampling the one or more items at one or more source locations of the source and during one or more timeslots, the one or more source locations and the one or more timeslots identified by the machine-learning model for the one or more items.

The online system 140 may generate (e.g., via the content presentation module 210), based on the selected source location and the selected timeslot, a user interface of a device associated with the user (e.g., the user client device 100) that includes a map of the set of source locations with information about the sample counter placed at the selected source location during the selected timeslot. The online system 140 may then cause (e.g., via the content presentation module 210) the user interface of the device to display the map with the information about the sample counter placed at the selected source location during the selected timeslot.

The online system 140 may retrieve (e.g., via the machine-learning training module 230), from a database of the online system 140 (e.g., the data store 240), first conversion data for a collection of items when sample counters were previously established for the collection of items and second conversion data for the collection of items when sample counters were not previously established for the collection of items. The online system 140 may train (e.g., via the machine-learning training module 230), using the first conversion data and the second conversion data, the machine-learning model to generate a set of initial values for a set of parameters of the machine-learning model.

Alternatively or additionally, the online system 140 may receive (e.g., via the machine-learning training module 230), from a set of devices of a set of sources associated with the online system 140 (e.g., source computing systems 120), information about changes in conversion for a collection of items caused by a set of sample counters established for the collection of items. The online system 140 may train (e.g., via the machine-learning training module 230), using the received information, the machine-learning model to generate a set of initial values for a set of parameters of the machine-learning model.

The online system 140 may collect (e.g., via the machine-learning training module 230) feedback data with information about conversion of the item caused by the sample counter that was placed for sampling the item at the selected source location and during the selected timeslot. The online system 140 may re-train the machine-learning model by updating (e.g., via the machine-learning training module 230), using the collected feedback data, the set of parameters of the machine-learning model.

Embodiments of the present disclosure are directed to the online system 140 that utilizes a trained machine-learning model to predicts incremental sales caused by a sample counter placed at a source location (e.g., store). In order to predict incremental sales caused by the sample counter, in-store data from various sources are utilized, such as in-store data collected via smart shopping carts 150.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network from at least one of a first set of devices associated with a first set of users of an online system or a second set of devices associated with a set of physical receptacles utilized by a second set of users of the online system for shopping at a set of source locations of a source associated with the online system, a plurality of signals related to conversion of an item by at least one of the first set of users or the second set of users;
accessing a machine-learning model of the online system, wherein the machine-learning model is trained to identify a ranked list of source locations from the set of source locations for placing a sample counter for sampling the item, each source location from the ranked list associated with a corresponding timeslot of a ranked list of timeslots;
applying the machine-learning model to output, based at least in part on the plurality of signals, a score for placing the sample counter for sampling the item at each source location from the set of source locations and during each timeslot of a set of timeslots, wherein the score is indicative of a predicted increase in conversion of the item caused by the sample counter placed at each source location and during each timeslot;
identifying, based on the score associated with at each source location and each timeslot, the ranked list of source locations and the ranked list of timeslots for placing the sample counter for sampling the item;
selecting, from the ranked list of source locations and the ranked list of timeslots, a source location and a timeslot for placing the sample counter for sampling the item;
generating, based on the selected source location and the timeslot, a decision signal for the source; and
communicating, via the network to a device associated with the source, the decision signal prompting the source to place the sample counter for sampling the item at the selected source location and during the selected timeslot.

2. The method of claim 1, wherein receiving the plurality of signals comprises:
receiving, from the device associated with the source and via the network, the plurality of signals including in-store order data with information about conversion of the item at the set of source locations.

3. The method of claim 1, wherein receiving the plurality of signals comprises:
receiving, from the first set of devices and via the network, the plurality of signals including purchase data with first information about conversion of the item at the set of source locations, second information about the item being in a first subset of in-store mode ordering lists at a first subset of the first set of devices, and third information about the item not being in a second subset of the in-store mode ordering lists at a second subset of the second set of devices.

4. The method of claim 1, wherein receiving the plurality of signals comprises:
gathering, via sensors mounted to the set of physical receptacles, in-store data with information about placing of the item in the set of physical receptacles at the set of source locations and information about sections of the set of source locations where the set of physical receptacles were located; and
receiving, from the second set of devices and via the network, the gathered in-store data as at least a portion of the plurality of signals.

5. The method of claim 1, wherein applying the machine-learning model comprises:
applying the machine-learning model to output, based at least in part on the plurality of signals, a ranked list of in-store locations for placing the sample counter for sampling the item, each in-store location of the ranked list of in-store locations associated with a source location of the ranked list of source locations.

6. The method of claim 1, wherein applying the machine-learning model comprises:
retrieving, from a database of the online system, data with information about a set of candidate items;
obtaining a second plurality of signals related to conversion of the set of candidate items at the set of source locations; and
applying the machine-learning model to output, further based on the retrieved data and the second plurality of signals, a ranked list of items from the set of candidate items, each item from the ranked list associated with a source location of the set of source locations and a timeslot for placing a corresponding sample counter for sampling each item.

7. The method of claim 6, further comprising:
selecting, from the ranked list of items, one or more items for placing one or more sample counters for sampling the one or more items;
generating, based on the selected one or more items, a second decision signal for the source; and
communicating, via the network to the device associated with the source, the second decision signal prompting the source to place the one or more sample counters for sampling the one or more items at one or more source locations of the source and during one or more timeslots, the one or more source locations and the one or more timeslots identified by the machine-learning model for the one or more items.

8. The method of claim 1, further comprising:
generating, based on the selected source location and the selected timeslot, a user interface of a device associated with the user that includes a map of the set of source locations with information about the sample counter placed at the selected source location during the selected timeslot; and
causing the user interface of the device to display the map with the information about the sample counter placed at the selected source location during the selected timeslot.

9. The method of claim 1, further comprising:
retrieving, from a database of the online system, first conversion data for a collection of items when sample counters were previously established for the collection of items and second conversion data for the collection of items when sample counters were not previously established for the collection of items; and
training, using the first conversion data and the second conversion data, the machine-learning model to generate a set of initial values for a set of parameters of the machine-learning model.

10. The method of claim 1, further comprising:
receiving, from a set of devices of a set of sources associated with the online system, information about changes in conversion for a collection of items caused by a set of sample counters established for the collection of items; and
training, using the received information, the machine-learning model to generate a set of initial values for a set of parameters of the machine-learning model.

11. The method of claim 1, further comprising:
collecting feedback data with information about conversion of the item caused by the sample counter that was placed for sampling the item at the selected source location and during the selected timeslot; and
re-training the machine-learning model by updating, using the collected feedback data, a set of parameters of the machine-learning model.

12. A computer program product comprising a non-transitory computer readable storage medium having instructions encoded thereon that, when executed by a processor, cause the processor to perform steps comprising:
receiving, via a network from at least one of a first set of devices associated with a first set of users of an online system or a second set of devices associated with a set of physical receptacles utilized by a second set of users of the online system for shopping at a set of source locations of a source associated with the online system, a plurality of signals related to conversion of an item by at least one of the first set of users or the second set of users;
accessing a machine-learning model of the online system, wherein the machine-learning model is trained to identify a ranked list of source locations from the set of source locations for placing a sample counter for sampling the item, each source location from the ranked list associated with a corresponding timeslot of a ranked list of timeslots;
applying the machine-learning model to output, based at least in part on the plurality of signals, a score for placing the sample counter for sampling the item at each source location from the set of source locations and during each timeslot of a set of timeslots, wherein the score is indicative of a predicted increase in conversion of the item caused by the sample counter placed at each source location and during each timeslot;
identifying, based on the score associated with at each source location and each timeslot, the ranked list of source locations and the ranked list of timeslots for placing the sample counter for sampling the item;
selecting, from the ranked list of source locations and the ranked list of timeslots, a source location and a timeslot for placing the sample counter for sampling the item;
generating, based on the selected source location and the timeslot, a decision signal for the source; and
communicating, via the network to a device associated with the source, the decision signal prompting the source to place the sample counter for sampling the item at the selected source location and during the selected timeslot.

13. The computer program product of claim 12, wherein the instructions further cause the processor to perform steps comprising:
receiving, from the device associated with the source and via the network, the plurality of signals including in-store order data with information about conversion of the item at the set of source locations.

14. The computer program product of claim 12, wherein the instructions further cause the processor to perform steps comprising:
receiving, from the first set of devices and via the network, the plurality of signals including purchase data with first information about conversion of the item at the set of source locations, second information about the item being in a first subset of in-store mode ordering lists at a first subset of the first set of devices, and third information about the item not being in a second subset of the in-store mode ordering lists at a second subset of the second set of devices.

15. The computer program product of claim 12, wherein the instructions further cause the processor to perform steps comprising:
gathering, via sensors mounted to the set of physical receptacles, in-store data with information about placing of the item in the set of physical receptacles at the set of source locations and information about sections of the set of source locations where the set of physical receptacles were located; and
receiving, from the second set of devices and via the network, the gathered in-store data as at least a portion of the plurality of signals.

16. The computer program product of claim 12, wherein the instructions further cause the processor to perform steps comprising:
applying the machine-learning model to output, based at least in part on the plurality of signals, a ranked list of in-store locations for placing the sample counter for sampling the item, each in-store location of the ranked list of in-store locations associated with a source location of the ranked list of source locations.

17. The computer program product of claim 12, wherein the instructions further cause the processor to perform steps comprising:
retrieving, from a database of the online system, data with information about a set of candidate items;
obtaining a second plurality of signals related to conversion of the set of candidate items at the set of source locations; and
applying the machine-learning model to output, further based on the retrieved data and the second plurality of signals, a ranked list of items from the set of candidate items, each item from the ranked list associated with a source location of the set of source locations and a timeslot for placing a corresponding sample counter for sampling each item.

18. The computer program product of claim 17, wherein the instructions further cause the processor to perform steps comprising:
selecting, from the ranked list of items, one or more items for placing one or more sample counters for sampling the one or more items;
generating, based on the selected one or more items, a second decision signal for the source; and
communicating, via the network to the device associated with the source, the second decision signal prompting the source to place the one or more sample counters for sampling the one or more items at one or more source locations of the source and during one or more timeslots, the one or more source locations and the one or more timeslots identified by the machine-learning model for the one or more items.

19. The computer program product of claim 12, wherein the instructions further cause the processor to perform steps comprising:
retrieving, from a database of the online system, first conversion data for a collection of items when sample counters were previously established for the collection of items and second conversion data for the collection of items when sample counters were not previously established for the collection of items;
training, using the first conversion data and the second conversion data, the machine-learning model to generate a set of initial values for a set of parameters of the machine-learning model;
collecting feedback data with information about conversion of the item caused by the sample counter that was placed for sampling the item at the selected location and during the selected timeslot; and
re-training the machine-learning model by updating, using the collected feedback data, the set of parameters of the machine-learning model.

20. A computer system comprising:
a processor; and
a non-transitory computer-readable storage medium having instructions that, when executed by the processor, cause the computer system to perform steps comprising:
receiving, via a network from at least one of a first set of devices associated with a first set of users of an online system or a second set of devices associated with a set of physical receptacles utilized by a second set of users of the online system for shopping at a set of source locations of a source associated with the online system, a plurality of signals related to conversion of an item by at least one of the first set of users or the second set of users;
accessing a machine-learning model of the online system, wherein the machine-learning model is trained to identify a ranked list of source locations from the set of source locations for placing a sample counter for sampling the item, each source location from the ranked list associated with a corresponding timeslot of a ranked list of timeslots;
applying the machine-learning model to output, based at least in part on the plurality of signals, a score for placing the sample counter for sampling the item at each source location from the set of source locations and during each timeslot of a set of timeslots, wherein the score is indicative of a predicted increase in conversion of the item caused by the sample counter placed at each source location and during each timeslot;
identifying, based on the score associated with at each source location and each timeslot, the ranked list of source locations and the ranked list of timeslots for placing the sample counter for sampling the item;
selecting, from the ranked list of source locations and the ranked list of timeslots, a source location and a timeslot for placing the sample counter for sampling the item;
generating, based on the selected location and the timeslot, a decision signal for the source; and
communicating, via the network to a device associated with the source, the decision signal prompting the source to place the sample counter for sampling the item at the selected source location and during the selected timeslot.
